(19) United States
(12) Patent Application Publication
(10) Pub. No.: US 2008/0113254 A1
(43) Pub. Date: May 15, 2008

(54) APPARATUS AND METHOD FOR MANAGING FLUIDS IN A FUEL CELL STACK

(76) Inventors: Andrew Leigh Christie, Vancouver (CA); Simon Farrington, Vancouver (CA); Christopher J. Richards, New Westminster (CA); Herwig R. Haas, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/850,264

(22) Filed: Sep. 5, 2007

Related U.S. Application Data
(60) Provisional application No. 60/824,803, filed on Sep. 7, 2006.

(51) Int. Cl. H01M 8/02; H01M 8/10

(52) U.S. Cl. 429/38; 429/30

(57) ABSTRACT

A flow field plate assembly for use in a fuel cell, a plurality of which can form a fuel cell stack, comprises first and second flow field plates and a body comprising a porous medium interposed between the first and second flow field plates, the porous medium being operable to allow passage of a fuel and an oxygen-containing gas therethrough, and block from passage therethrough, a flow of liquids to prevent water collection and ice formation, which may block passages formed on at least a portion of the first and/or second flow field plates.

### CROSS-REFERENCE TO RELATED APPLICATION

This application claims the benefit under 35 U.S.C. § 119(e) of U.S. Provisional Patent Application No. 60/824,803 filed Sep. 7, 2006 where this provisional application is incorporated herein by reference in its entirety.

### BACKGROUND OF THE INVENTION

1. Field of the Invention

The present invention generally relates to electrochemical systems, and more particularly, to an apparatus and method for managing fluids in a fuel cell stack.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically promotes the desired electrochemical reactions at the electrodes. The location of the electrocatalyst generally defines the electrochemically active area.

One type of electrochemical fuel cell is a proton exchange membrane (PEM) fuel cell 10 shown in FIG. 2. PEM fuel cells 10 generally employ a membrane electrode assembly (MEA) 5 comprising a solid polymer electrolyte or ion-exchange membrane 2 disposed between two electrodes 1, 3, as shown in FIG. 1. Each electrode 1, 3 typically comprises a porous, electrically conductive substrate, such as carbon fiber paper or carbon cloth, which provides structural support to the membrane 2 and serves as a fluid diffusion layer. The membrane 2 is ion conductive, typically proton conductive, and acts both as a barrier for isolating the reactant streams from each other and as an electrical insulator between the two electrodes 1, 3. A typical commercial PEM 2 is a sulfonated perfluorocarbon membrane sold by E.I. Du Pont de Nemours and Company under the trade designation NAFION®. The electrocatalyst is typically a precious metal composition (e.g., platinum metal black or an alloy thereof) and may be provided on a suitable support (e.g., fine platinum particles supported on a carbon black support).

As shown in FIG. 2, in a fuel cell 10, the MEA 2 is typically interposed between two separator plates 11, 12 that are substantially impermeable to the reactant fluid streams. Such plates 11, 12 are referred to hereinafter as flow field plates 11, 12. The flow field plates 11, 12 provide support for the MEA 5. Fuel cells 10 are typically advantageously stacked to form a fuel cell stack 50 having end plates 17, 18, which retain the stack 50 in the assembled state as illustrated in FIG. 3.

FIG. 4 illustrates a conventional electrochemical fuel cell system 60, as more specifically described in U.S. Pat. Nos. 6,066,409 and 6,232,008, which are incorporated herein by reference. As shown, the fuel cell system 60 includes a pair of end plate assemblies 62, 64, and a plurality of stacked fuel cells 66, each comprising an MEA 68, and a pair of flow field plates 70a, 70b (collectively referred to as flow field plates 70). Between each adjacent pair of MEAs 68 in the system 60, there are two flow field plates 70a, 70b that have adjoining surfaces. The flow field plates 70 can be fabricated from a unitary plate forming a bipolar plate. A tension member 72 extends between the end plate assemblies 62, 64 to retain and secure the system 60 in its assembled state. A spring 74 with clamping members 75 can grip an end of the tension member 72 to apply a compressive force to the fuel cells 66 of the system 60.

Fluid reactant streams are supplied to and exhausted from internal manifolds and passages in the system 60 via inlet and outlet ports 76 in the end plate assemblies 62, 64. Aligned internal reactant manifold openings 78, 80 in the MEAs 68 and flow field plates 70, respectively, form internal reactant manifolds extending through the system 60. As one of ordinary skill in the art will appreciate, in other representative electrochemical fuel cell stacks, reactant manifold openings may instead be positioned to form edge or external reactant manifolds.

A perimeter seal 82 can be provided around an outer edge of both sides of the MEA 68. Furthermore manifold seals 84 can circumscribe the internal reactant manifold openings 78 on both sides of the MEA 68. When the system 60 is secured in its assembled, compressed state, the seals 82, 84 cooperate with the adjacent pair of plates 70 to fluidly isolate fuel and oxidant reactant streams in internal reactant manifolds and passages, thereby isolating one reactant stream from the other and preventing the streams from leaking from the system 60.

As illustrated in FIG. 4, each MEA 68 is positioned between the active surfaces of two flow field plates 70. Each flow field plate 70 has flow field channels 86 (partially shown) on the active surface thereof, which contacts the MEA 68 for distributing fuel or oxidant fluid streams to the active area of the contacted electrode of the MEA 68. The reactant flow field channels 86 on the active surface of the plates 70 fluidly communicate with the internal reactant manifold openings 80 in the plate 70 via reactant supply/exhaust passageways comprising back-feed channels 90 located on the non-active surface of the plate 70 and back-feed ports 92 extending through (i.e., penetrating the thickness) the plate 70, and transition regions 94 located on the active surface of the plate 70. As shown, with respect to one port 92, one end of the port 92 can open to the back-feed channel 90, which can in turn be open to the internal reactant manifold opening 80, and the other end of the port 92 can be open to the transition region 94, which can in turn be open to the reactant flow field channels 86.

Instead of two plates 70a, 70b, one plate 70 unitarily formed or alternatively fabricated from two half plates 70a, 70b can be positioned between the cells 66, forming bipolar plates as discussed above.

The flow field plates 70 also have a plurality of typically parallel flow field channels 96 formed in the non-active surface thereof. The channels 96 on adjoining pairs of plates 70 cooperate to form coolant flow fields 98 extending laterally between the opposing non-active surfaces of the adjacent fuel cells 66 of the system 60 (generally perpendicular to the stacking direction). A coolant stream, such as air or other cooling media may flow through these flow fields 98 to remove heat generated by exothermic electrochemical reactions, which are induced inside the fuel cell system 60.

In the conventional fuel cell system 60, water typically accumulates in the flow field channels 86, back-feed channels 90 and back-feed ports 92. As gas, such as reactants and/or oxidants, is injected into the flow field channels 86, the gas pressure and movement may flush some of the accumulated water through the above-described outlets.

If a relatively large amount of water collects in a localized region of the flow field channels 86, back-feed channels 90 and/or back-feed port 92, the water may block the channels 86, 90 or port 92. If the accumulated water blocks the channels 86, 90 or port 92, gas flow can be adversely affected, and in extreme cases, cease. Consequently, as the reactants and/or oxidants in the gas residing in the blocked channels 86, 90 or port 92 are depleted, electrical output and fuel efficiency of the fuel cell decreases.

Such water accumulation can also lead to ice formation before and during freeze startups. Although purging the water from the system is one option for preventing water accumulation, regions of low purge velocity tend to retain water during a purge. Furthermore, due to the large ratio of capillary forces from the back-feed ports 92 to the reactant manifold openings 78, water tends to wick back into the exit of the back-feed port 92 after the purge. Therefore, after the purge, regions of low purge velocity in the reactant manifold openings 78 typically store relatively large amounts of water, which may wick or otherwise move back into the back-feed channels 90 and/or back-feed port 92. This water freezes under appropriate environmental conditions, resulting in ice blockage. These blockages typically prevent efficient reactant access and flow to the flow field channels 86 and may cause uneven flow sharing and fuel starvation in the fuel cell system 60.

In addition to purging the water from the system 60, other methods of mitigating ice blockages include operating the fuel cell system 60 extremely dry; however, even then, some ice blockage occurs because it is nearly impossible to completely prevent water from exiting the fuel cells 66. Furthermore, operating fuel cell systems in extremely dry conditions typically impedes performance and reduces the fatigue life of the system 60.

Those of ordinary skill in the art will appreciate that other configurations for the reactant supply manifolds and back-feed channels and ports exist, nearly all of which suffer from the above obstacles. For example, FIG. 5 illustrates a front view of a non-active side of a flow field plate 100 of another conventional system. Reactant back-feed channels 102 and ports 104 can experience water formation and ice blockage as described above. FIG. 5 more clearly conveys the adverse effect of ice blockage in these channels 102 and ports 104 on the operation of the fuel cell system because if these channels 102 and ports 104 are blocked or even partially obstructed, reactants such as fuel and oxidants cannot efficiently reach the active side of the flow field plate 100 to support reactions necessary for the system to operate efficiently.

Accordingly, there is a need for an apparatus and method for managing fluid flow in a fuel cell stack that substantially prevents water retention and ice-blockage formation in the fuel cell stack and that is inexpensive, space conserving and easy to implement.

### BRIEF SUMMARY OF THE INVENTION

According to one embodiment, a flow field plate assembly for use in a fuel cell stack having a plurality of fuel cells comprising a membrane electrode assembly (MEA), comprises a first flow field plate positionable on an anode side of the MEA of a first fuel cell, at least a portion of a first side of the first flow field plate having a reactant manifold opening and at least one reactant flow field channel adapted to direct a fuel to at least a portion of an anode electrode layer of the MEA, a second flow field plate positionable on a cathode side of the MEA of a second fuel cell, adjacent the first fuel cell, at least a portion of a first side of the second flow field plate having a reactant manifold opening and at least one reactant flow field channel adapted to direct an oxygen-containing gas to at least a portion of the cathode electrode layer, and at least one body comprising a porous medium positioned at least partially adjacent at least one of the first and second flow field plates, the porous medium being operable to allow passage of the fuel and the oxygen-containing gas therethrough, and block from passage therethrough, a flow of liquids, when the flow field plate is installed in the fuel cell stack and the fuel cell stack is in operation.

According to another embodiment, a fuel cell stack comprises a plurality of fuel cells, each fuel cell having a membrane electrode assembly (MEA) having an ion-exchange membrane interposed between anode and cathode electrode layers, a first flow field plate positioned on an anode side of the MEA, at least a portion of a first side of the first flow field plate having a reactant manifold opening, at least one reactant flow field channel adapted to direct a fuel toward at least a portion of the anode electrode layer, and means for directing the fuel interposed between the reactant manifold opening and the reactant flow field channel, a second flow field plate positioned on a cathode side of the MEA, at least a portion of a first side of the second flow field plate having a reactant manifold opening, at least one reactant flow field channel adapted to direct an oxygen-containing gas toward at least a portion of the cathode electrode layer, and means for directing the oxygen-containing gas interposed between the reactant manifold opening and the reactant flow field channel, and at least one body comprising a porous medium positioned at least partially adjacent at least one of the first and second flow field plates, the porous medium being operable to allow passage of the fuel and the oxygen-containing gas therethrough, and block from passage therethrough, a flow of liquids.

According to yet another embodiment, a method for managing fluids in a fuel cell stack to prevent liquid collection and ice formation, comprises providing at least one body having a porous medium adjacent a flow field plate of at least one fuel cell of the fuel cell stack between a reactant manifold opening and a reactant flow field channel of the flow field plate to allow passage of at least one of a fuel and an oxygen-containing gas therethrough, and block from passage therethrough, a flow of liquids.

### BRIEF DESCRIPTION OF THE SEVERAL VIEWS OF THE DRAWING(S)

FIG. 1 is an exploded isometric view of a membrane electrode assembly according to the prior art.

FIG. 2 is an exploded isometric view of a fuel cell according to the prior art.

FIG. 3 is an isometric view of a fuel cell stack according to the prior art.

FIG. 4 is an exploded isometric view of a fuel cell system according to the prior art.

FIG. 5 is a front view of a portion of a flow field plate according to the prior art.

FIG. 6 is a front view of a portion of a flow field plate according to an embodiment of the present invention.

FIG. 7A is a front view of a portion of a flow field plate according to another embodiment of the present invention.

FIG. 7B is a cross-sectional view of a portion of the flow field plate of FIG. 7A, viewed across section 7B-7B.

FIG. 8A is a front view of a portion of a flow field plate according to yet another embodiment of the present invention.

FIG. 8B is a rear view of the flow field plate of FIG. 8A.

FIG. 9A is a front view of a portion of a flow field plate according to still another embodiment of the present invention.

FIG. 9B is a cross-sectional view of a portion of the flow field plate of FIG. 9A according to one embodiment, viewed across section 9B-9B.

FIG. 9C is a cross-sectional view of a portion of the flow field plate of FIG. 9A according to another embodiment, viewed across section 9C-9C.

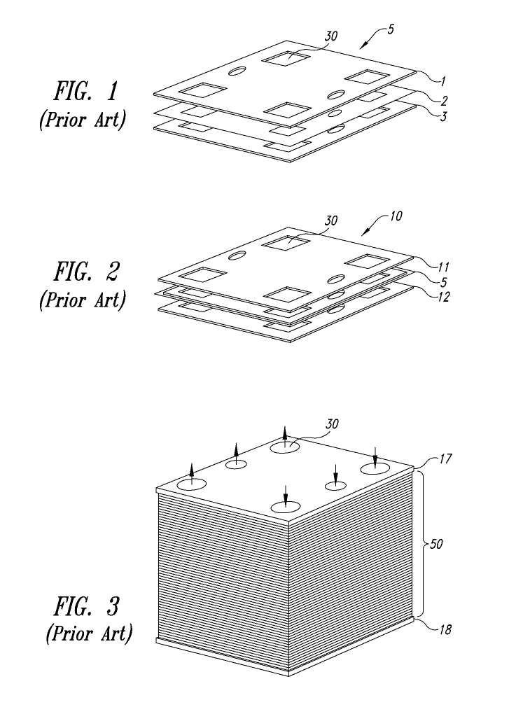

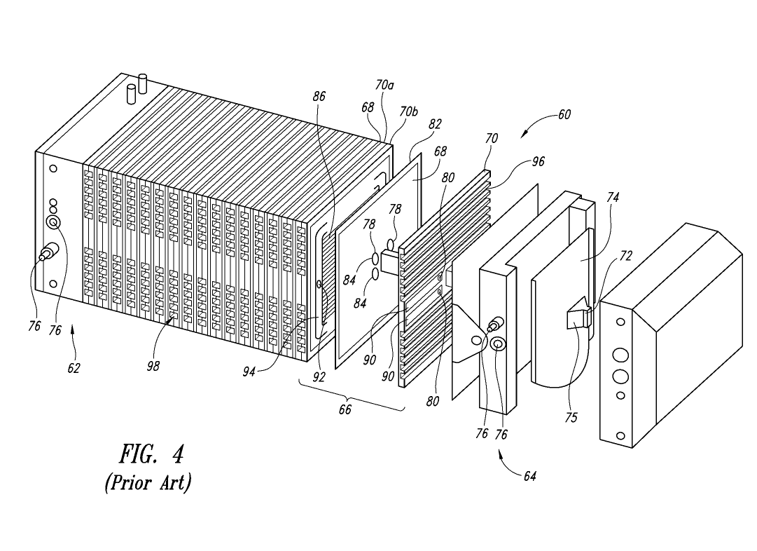

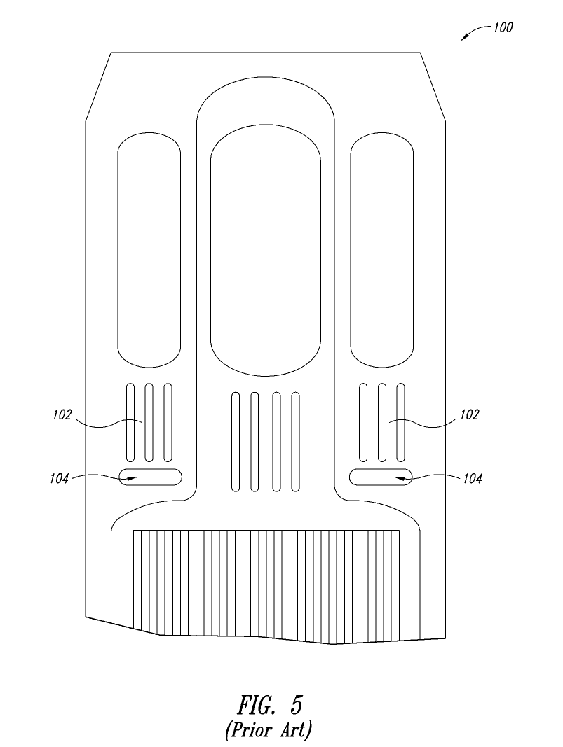

### DETAILED DESCRIPTION OF THE INVENTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

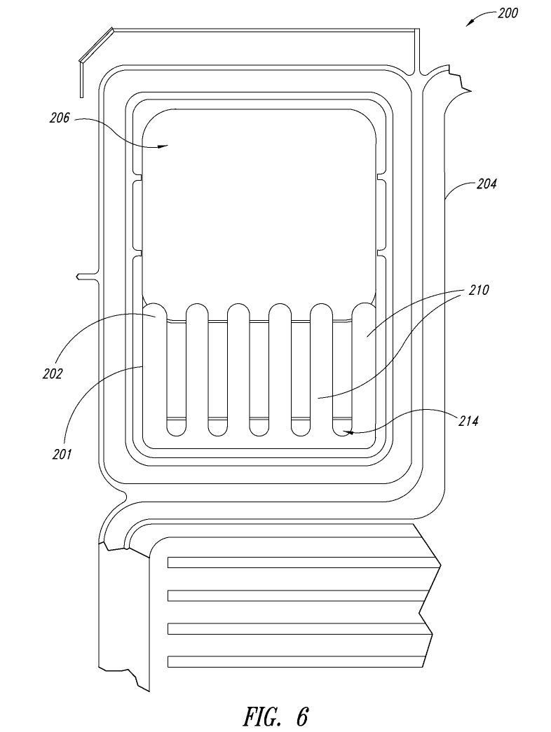

FIG. 6 illustrates one embodiment of the present invention, in which a fuel cell stack 200 comprises a body 201 having a porous medium 202 interposed between two adjacent flow field plates. One of the flow field plates 204 is depicted in FIG. 6; the other is not shown for clarity of illustration of the porous medium 202. The porous medium 202 comprises a porous material that allows passage of reactant gases, for example a fuel, such as a hydrogen-containing fuel, and an oxygen-containing gas, therethrough, and blocks from passage a flow of liquids such as water. The porous medium 202 can be positioned in any region that tends to collect water. For example, as shown in FIG. 6, the porous medium 202 can be positioned proximate and/or adjacent a reactant manifold opening 206. The porous medium may comprise limbs 210 that form channels and provide a pathway for only reactant gases, or in case of a coolant manifold opening, gaseous coolant media, toward a back-feed port 214, which terminates on an active side of the plate 204. If necessary, portions of the flow field plate or half plate 204 may be machined to conform to a shape of and receive the porous medium 202. In plates where the reactant manifold opening 206 is on the same side as reactant flow channels, the porous medium 202 may extend from the manifold to the reactant flow channels.

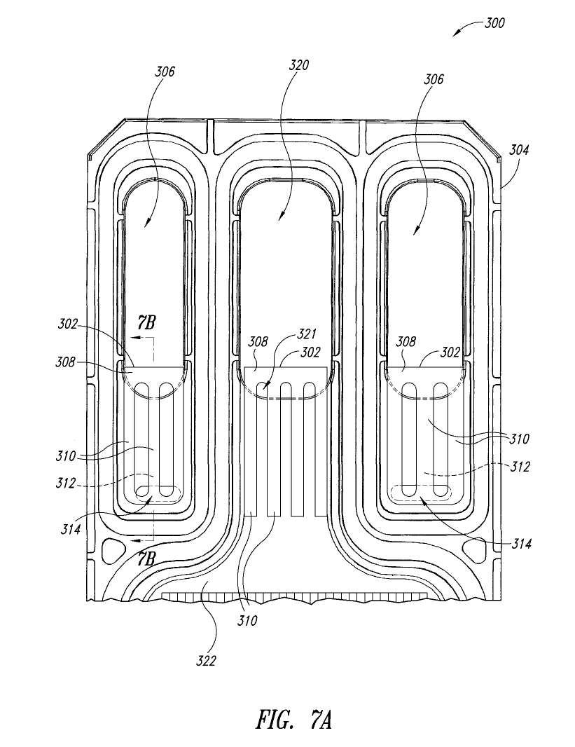

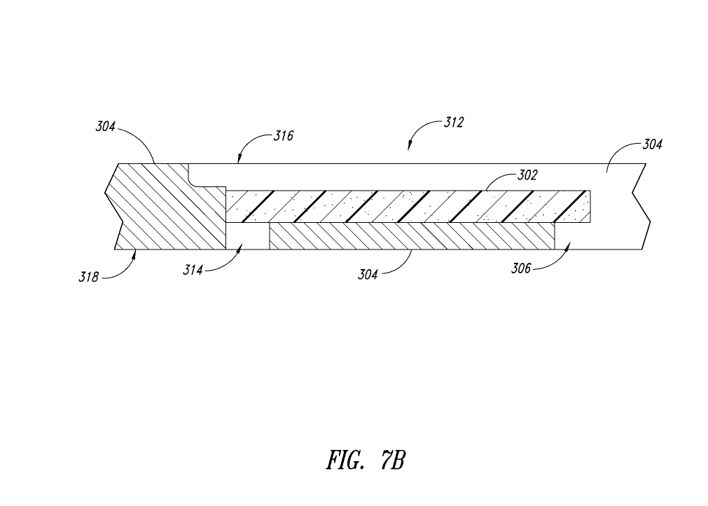

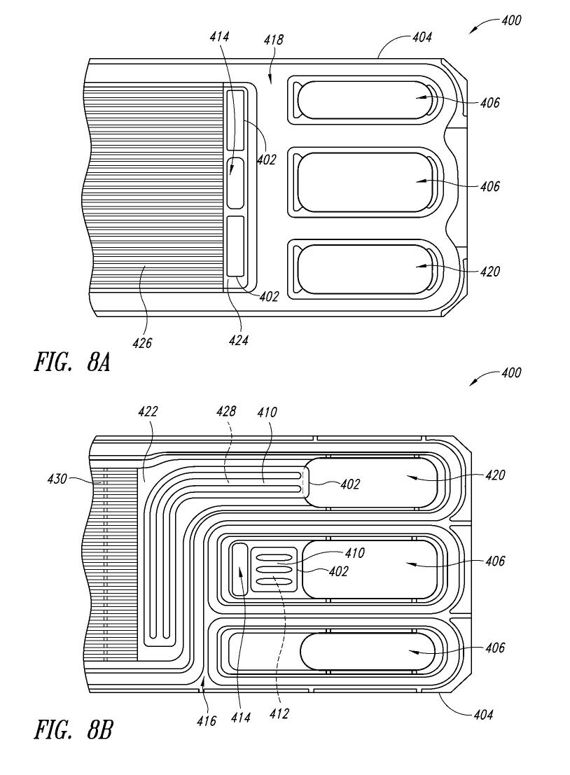

In another embodiment as shown in FIG. 7A, a fuel cell stack 300 may comprise a plurality of porous media 302 arranged in distinct locations adjacent the flow field plate 304. For example, the porous media 302 can be positioned adjacent a reactant manifold opening 306, for example a fuel reactant manifold opening 306. In one aspect, the porous media 302 may comprise at least one base 308 and a plurality of limbs 310 extending from the base 308. Alternatively, the porous media 302 may comprise two bases 308 at each end thereof, the limbs 310 extending therebetween. The limbs 310 can be configured to at least partially, or fully, occupy a volume of the back-feed channels 312 (or replace the back-feed channels 312) and the back-feed ports 314.

As better shown in FIG. 7B, the porous media 302 can be positioned in at least a portion of the back-feed channels 312 on an inactive side 316 of the flow field plate 304 and cover at least a portion of the back-feed ports 314, which terminate on an active side 318 of the flow field plate 304. In some embodiments, the porous media 302 may create a path through which liquids such as water cannot pass while reactant gases, such as a hydrogen-containing fuel and/or an oxygen-containing gas, for example air, can pass therethrough. Therefore, reactant gases can gain access to the active side 318 even when the fuel cell stack 300 is cooled below a freezing temperature.

In some embodiments, the porous media 302 may comprise material that in addition to allowing reactant gases through also allows water vapor through, while blocking liquid water and other liquids. In other embodiments, the porous media 302 may comprise material that also blocks water vapor and only allows reactant gases to pass through. Furthermore, the porous media 302 may comprise material that is hydrophobic, such as TEFLON® to further repel water and prevent water collection and ice blockage formation in regions proximate the porous media 302. As one example, the porous media 302 may comprise carbon fiber paper (CFP), such as those available from Toray, for example, TGP-30 (Toray Graphite Paper) CFP material coated with TEFLON®.

As illustrated in FIG. 7A, the porous media can also be positioned in areas of potential water collection and ice formation that do not involve the back-feed channels 312 and/or back-feed ports 314. For example, a coolant manifold opening 320 that supplies coolant in the form of a gas or vapor, for example air or cooled water vapor, delivers the coolant to a transition region 322 and then to coolant flow channels. The transition region 322 can be prone to water collection and ice formation and/or blockage. Accordingly, the porous media 302 can be positioned adjacent the coolant manifold opening 320 and the transition region 322 to prevent water and other liquids from entering the transition region 322 and allow continuous coolant flow in the coolant flow channels during the operation of the fuel cell stack 300.

Alternatively, where the coolant is a liquid and the porous medium 302 needs to be installed for manufacturing purposes, the porous medium 302 may be positioned with respect to the coolant manifold opening 320 such that openings 321 are provided between the limbs 310 coincident with the coolant manifold opening 320. Further, the opposing end of the porous medium 302, toward the transition region 322, can comprise open channels (i.e. not include the base 308) so that liquid coolant can reach the coolant flow channels (not shown).

One of ordinary skill in the art having reviewed this disclosure will appreciate that an embodiment of the present invention can be used with any flow field plate, on either the active or the inactive sides of the flow field plates, and/or on an oxidant or a fuel reactant side of the flow field plates to create a gaseous and/or vapor exclusive pathway and ensure continuous reactant and/or coolant flow in a fuel cell stack.

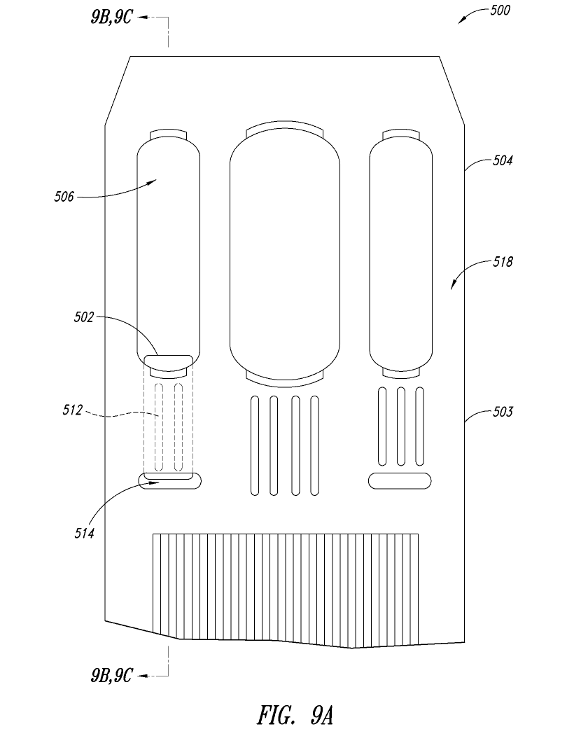

For example, FIGS. 8A and 8B respectively illustrate a portion of an active side 418 and an inactive side 416 of a flow field plate 404 of another fuel cell stack 400, the flow field plate 404 having a different design in which the reactant manifold openings 406 are adjacent each other and the coolant manifold opening 420 is positioned to one side, adjacent one of the reactant manifold openings 406.

At least one of the reactant manifold openings 406 may comprise back-feed channels 412 on the inactive side 416, which are in fluid communication with a back-feed port 414, which in turn is in fluid communication with the active side 418 to deliver reactants thereto. When the reactants arrive through the back-feed port 414 to the active side 418, they enter a reactant transition region 424, which guides the reactants to the reactant flow channels 426 to support proper electrochemical reactions. Further, the coolant manifold opening 420 may lead to feed channels 428, directing the coolant to the coolant transition region 422, which leads to coolant flow field channels 430.

The active side 418 and inactive side 416 of the flow field plate 404 may be fitted and/or manufactured with porous media 402. In plates 404 where the porous media 402 are fitted, the porous media 402 can be an insert and extend to at least partially, and in some embodiments fully, occupy a volume of the back-feed channels 412 and or the coolant feed channels 428. Alternatively, when the flow field plates 404 are manufactured with the porous media 402, the porous media 402 may replace the back-feed channels 412 and/or the coolant feed channels 428. The porous media 402 may include a height and/or depth dimension that is substantially equivalent to a height and/or depth dimension of the back-feed channels 412 and/or the coolant feed channels 428.

Another example of a location on the flow field plates 404 in which the porous media 402 may be placed can be adjacent the back-feed port 414 in the reactant transition region 424 of the active side 418 as shown in FIG. 8A. The reactant transition region 424 can experience water collection and when low temperatures are experienced, ice blockage. Therefore, the porous media 402 at least partially covering the reactant transition region 424 can prevent passage of water while allowing reactant gases to pass and access the reactant flow field channels 426.

The porous media 402 can comprise any shape, for example the porous media 402 may comprise a solid shape such as a rectangle similar to the porous media 402 positioned adjacent the back-feed port 414 on the active side 418. Another example is an irregular shape having linear and curvilinear portions conforming to a direction of flow of fluids adjacent the flow field plate 404. An example of such a porous media 402 is illustrated in FIG. 8B, at least partially covering the coolant transition region 428. Additionally, or alternatively, the porous media 402 may comprise channels formed and/or interposed between limbs 410 of the porous media 402, similar to the limbs 410 of the porous media 402 illustrated in FIG. 8B adjacent the fluid manifold opening 406 and/or adjacent the coolant manifold opening 420. One of ordinary skill in the art having reviewed this disclosure will appreciate these and other configurations that the porous media may comprise to make it suitable for conforming to a region on the flow field plate that may be prone to water collection and, in low temperatures, ice formation.

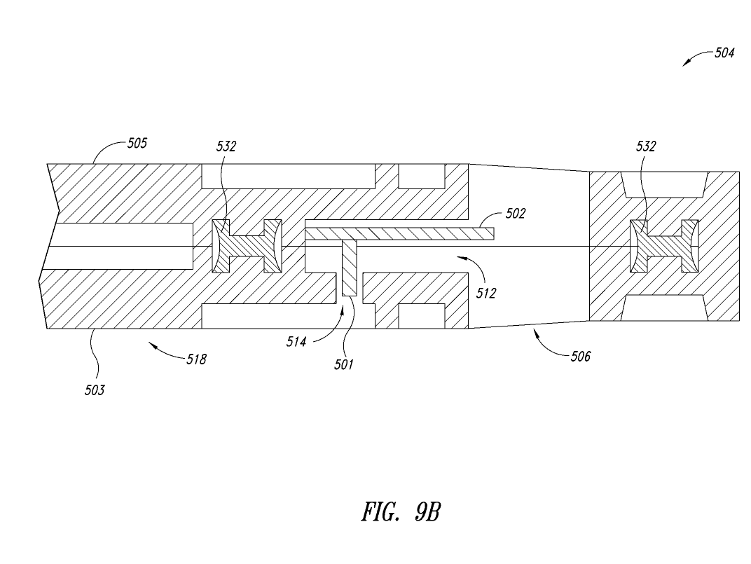

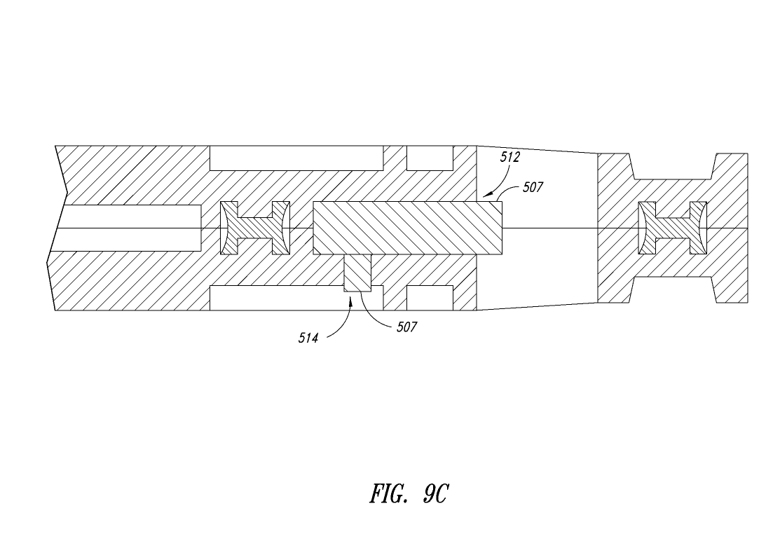

FIG. 9A illustrates a portion of another fuel cell stack 500 according to still another embodiment and comprising a flow field plate assembly 504 having first and second half plates 503, 505 (FIG. 9B). The surface of the flow field plate assembly 504 depicted in FIG. 9A is the active side 518 of the half plate 503. FIG. 9B illustrates one embodiment of a cross-sectional view across a portion of the flow field plate assembly 504 that coincides with the reactant manifold opening 506, the back-feed channel 512 and the back-feed port 514. The half plates 503, 505 are bonded together on their inactive sides via bonding joints 532. Depending on whether reactants and/or products of electrochemical reactions are being fed to or exhausted from a corresponding membrane electrode assembly (not shown), the reactants and/or products travel to or from the reactant manifold openings 506 through the back-feed channels 512 from and to the back-feed ports 514.

In one embodiment, a thin porous media 502 can be positioned to partially occupy the back-feed channel 512 through which reactants travel to be exhausted from or fed to the corresponding membrane electrode assembly, as illustrated in FIG. 9B. Only reactant gases, such as the fuel and/or the oxidant, and not liquids, such as water, can travel through the thin porous media 502. The separated liquid may otherwise be routed for disposal or recycled and used for a purpose in the fuel cell stack, such as a cooling medium to cool the fuel cell stack. The reactant gases on the other hand have a pathway available to the back-feed ports 514 without being obstructed by ice blockage. In other embodiments, the thin porous media 502 may comprise an optional extension 501 further ensuring that the reactant gases reach the active side 518 of the flow field plate assembly 504.

It is understood that the porous media 502 need not be centered in the back-feed channel 512; it can be positioned anywhere in the back-feed channel 512. The thin porous media 502 can include a thickness that does not significantly affect a pressure differential between an entry and an exit of the back-feed channels 512; for example, the porous media 502 can comprise a thickness of approximately 100 microns.

In another embodiment as shown in FIG. 9C, a larger and/or thicker porous media 507 can be positioned to substantially occupy the back-feed channel 512 and/or the back-feed port 514. Accordingly, substantially no liquid can travel through the back-feed channel 512, which may be desirable in applications or configurations in which water is collected outside the back-feed channels 512 and routed out of the fuel cell stack 500 or recycled back into the fuel cell stack 500.

Those of ordinary skill in the art having reviewed this disclosure will appreciate that the porous media 506, 507 can also be incorporated in bipolar plates in similar fashion as that described herein in conjunction with any of the embodiments.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereof.

1. A flow field plate assembly for use in a fuel cell stack having a plurality of fuel cells comprising a membrane electrode assembly (MEA), the flow field plate assembly comprising:
a first flow field plate positionable on an anode side of the MEA of a first fuel cell, at least a portion of a first side of the first flow field plate having a reactant manifold opening and at least one reactant flow field channel adapted to direct a fuel to at least a portion of an anode electrode layer of the MEA;
a second flow field plate positionable on a cathode side of the MEA of a second fuel cell, adjacent the first fuel cell, at least a portion of a first side of the second flow field plate having a reactant manifold opening and at least one reactant flow field channel adapted to direct an oxygen-containing gas to at least a portion of the cathode electrode layer; and
at least one body comprising a porous medium positioned at least partially adjacent at least one of the first and second flow field plates, the porous medium being operable to allow passage of the fuel and the oxygen-containing gas therethrough, and block from passage therethrough, a flow of liquids, when the flow field plate is installed in the fuel cell stack and the fuel cell stack is in operation.

2. The flow field plate assembly of claim 1 wherein the porous medium is coated with a hydrophobic material.

3. The flow field plate assembly of claim 1 wherein the body is positioned adjacent at least one of the reactant flow field channels.

4. The flow field plate assembly of claim 1 wherein the first and second flow field plates, each comprise a second side opposite the first sides of the first and second flow field plates, respectively, and the body is interposed between at least a portion of the second sides.

5. The flow field plate assembly of claim 4 wherein at least a portion of at least one of the second sides comprises at least one back-feed channel in fluid communication with the reactant manifold opening and a back-feed port, the back-feed port being in fluid communication with the reactant flow field channel of the first side to deliver at least one of the fuel and the oxygen-containing gas to the reactant flow field channel, and the body is positioned adjacent the back-feed channel, occupying at least a portion of a volume of the back-feed channel.

6. The flow field plate assembly of claim 5 wherein the body substantially occupies an entire volume formed by at least one of the back-feed channel and the back-feed port.

7. The flow field plate assembly of claim 1 wherein at least one of the first and second flow field plates comprises a reactant transition region proximate the reactant flow field channel, and the body is positioned adjacent the reactant transition region, occupying at least a portion of a volume formed by the reactant transition region.

8. The flow field plate assembly of claim 1 wherein the body is integrated with at least one of the first and second flow field plates.

9. The flow field plate assembly of claim 1 wherein the body comprises at least one channel, configured to direct at least one of the oxygen-containing gas and the fuel, when the flow field plate assembly is installed in the fuel cell stack and the fuel cell stack is in operation.

10. The flow field plate assembly of claim 1 wherein the body comprises carbon fiber paper at least partially coated with TEFLON®.

11. A fuel cell stack comprising a plurality of fuel cells, each fuel cell having:
a membrane electrode assembly (MEA) having an ion-exchange membrane interposed between anode and cathode electrode layers;
a first flow field plate positioned on an anode side of the MEA, at least a portion of a first side of the first flow field plate having a reactant manifold opening, at least one reactant flow field channel adapted to direct a fuel toward at least a portion of the anode electrode layer, and means for directing the fuel interposed between the reactant manifold opening and the reactant flow field channel;
a second flow field plate positioned on a cathode side of the MEA, at least a portion of a first side of the second flow field plate having a reactant manifold opening, at least one reactant flow field channel adapted to direct an oxygen-containing gas toward at least a portion of the cathode electrode layer, and means for directing the oxygen-containing gas interposed between the reactant manifold opening and the reactant flow field channel; and
at least one body comprising a porous medium positioned at least partially adjacent at least one of the first and second flow field plates, the porous medium being operable to allow passage of the fuel and the oxygen-containing gas therethrough, and block from passage therethrough, a flow of liquids.

12. The fuel cell stack of claim 11 wherein the porous medium is coated with a hydrophobic material.

13. The fuel cell stack of claim 11 wherein the body is positioned adjacent at least one of the means for directing the fuel and the means for directing the oxygen-containing gas.

14. The fuel cell stack of claim 11 wherein a second side of the first flow field plate of at least one fuel cell is at least partially contiguous a second side of the second flow field plate of an adjacent fuel cell, and the body is interposed between at least a portion of the second sides.

15. The fuel cell stack of claim 14 wherein at least a portion of at least one of the second sides comprises at least one back-feed channel in fluid communication with the reactant manifold opening and a back-feed port, the back-feed port being in fluid communication with the reactant flow field channel of the first side to deliver at least one of the fuel and the oxygen-containing gas to the reactant flow field channel, and the body is positioned adjacent the back-feed channel, occupying at least a portion of a volume of the back-feed channel.

16. The fuel cell stack of claim 15 wherein the body substantially occupies an entire volume formed by at least one of the back-feed channel and the back-feed port.

17. The fuel cell stack of claim 11 wherein at least one of the first and second flow field plates comprises a reactant transition region proximate the reactant flow field channel, and the body is positioned adjacent the reactant transition region, occupying at least a portion of a volume formed by the reactant transition region.

18. The fuel cell stack of claim 11 wherein the body is integrated with the at least one of the first and second flow field plates.

19. The fuel cell stack of claim 11 wherein the body comprises at least one channel, and at least one of the means for directing the fuel and the means for directing the oxygen-containing gas is the porous medium.

20. The fuel cell stack of claim 11 wherein the body comprises carbon fiber paper at least partially coated with TEFLON®.

21. A flow field plate for use in a fuel cell comprising a porous medium positioned in a reactant flow path adapted to allow passage of a fuel and an oxygen-containing gas therethrough, and block from passage therethrough, a flow of liquids, when the flow field plate is installed in the fuel cell, a plurality of which form a fuel cell stack, and the fuel cell stack is in operation.

22. A method for managing fluids in a fuel cell stack to prevent liquid collection and ice formation, the method comprising:
providing at least one body having a porous medium adjacent a flow field plate of at least one fuel cell of the fuel cell stack between a reactant manifold opening and a reactant flow field channel of the flow field plate to allow passage of at least one of a fuel and an oxygen-containing gas therethrough, and block from passage therethrough, a flow of liquids.
